(19) United States
(12) Patent Application Publication
(10) Pub. No.: US 2017/0368581 A1
(43) Pub. Date: Dec. 28, 2017

(54) CLEANING DEVICE

(71) Applicant: Picote Oy Ltd., Porvoo (FI)

(72) Inventor: Mika Lokkinen, Porvoo (FI)

(21) Appl. No.: 15/194,619

(22) Filed: Jun. 28, 2016

(51) Int. Cl. B08B 9/043; B08B 9/045

(52) U.S. Cl. CPC B08B 9/0436; B08B 9/045

(57) ABSTRACT

A cleaning device for cleaning an inner surface of a pipe. The cleaning device has first and second bodies each having a connector for connecting a drive shaft and being rotatable about a rotation axis with the drive shaft. The cleaning device also has multiple link connections defined in said first body and in said second body and multiple chains of links extending between the link connections of said bodies. The links consist of a helically wound metal wire for detachably connecting the links to each other and/or to the link connections. At least a part of said links has a tip of the helically wound metal wire bent radially outwardly from said helical winding for cleaning the inner surface of the pipe when the first body and the second body are rotated with the drive shaft.

### FIELD OF THE INVENTION

The present invention relates to a cleaning device, and particularly to a cleaning device for removing rust and residues inside a pipe.

### BACKGROUND OF THE INVENTION

Installed pipelines in buildings and underground can be rehabilitated without opening structures or digging the ground. The trenchless rehabilitation allows a quick and durable rehabilitation of pipes within buildings and underground pipelines. A resin impregnated liner is installed in a pipe with an inversion drum using air pressure to invert the liner into the pipe. Once the liner is installed air pressure is maintained on an elevated level until the resin within the liner settles and the liner forms a rigid pipe against the inner surface of the old pipe. Before the liner can be installed, the pipe must be cleaned thoroughly and any rust or residues must be removed from the pipe.

A solution of the prior art is to use chains having sharp-edged pieces of hard metal welded to links of the chains. By rotating these chains inside a pipe the pieces of hard metal make contact with the inner surface of the pipe and scrape it clean.

One of the problems associated with the above arrangement is that it is tedious manual labor to weld the pieces of hard metal to the links of the chain and it takes a long time to manufacture these chains. Another problem is that the chains cannot be sharpened once the sharp edges have worn out and become dull.

### BRIEF DESCRIPTION OF THE INVENTION

An object of the present invention is to provide a cleaning device that is easy to manufacture, repairable and adjustable.

The present invention is based on the idea of providing two bodies and link chains between them. The links are made of a single wire and have a radially outwardly bent tip for achieving a cleaning effect. The links are configured to be attached to and detached from either one of the two bodies or from each other without having to use special tools.

An advantage of the arrangement of the present invention is that the device is simple and fast to manufacture and can be assembled, repaired and altered at a working site by anyone without having to use any special tools.

### BRIEF DESCRIPTION OF THE DRAWINGS

In the following, the present invention is described in greater detail by means of preferred embodiments with reference to the accompanying drawings, in which

FIG. 1 is a perspective view of a cleaning device according to an embodiment of the present invention;

FIG. 2 is a perspective view of a body of the cleaning device according to the present invention; and

FIG. 3 is a perspective view of a link of the cleaning device according to the present invention.

### DETAILED DESCRIPTION OF THE INVENTION

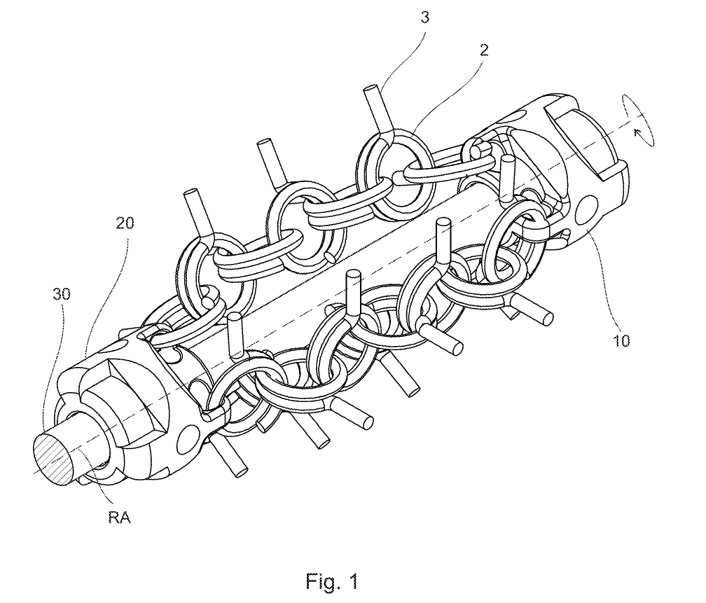

FIG. 1 is illustrates a cleaning device according to an embodiment of the present invention. The cleaning device can be used in pipe rehabilitation work to clean an inner surface of a pipe by removing rust and residues of unwanted material from the pipe before a lining operation.

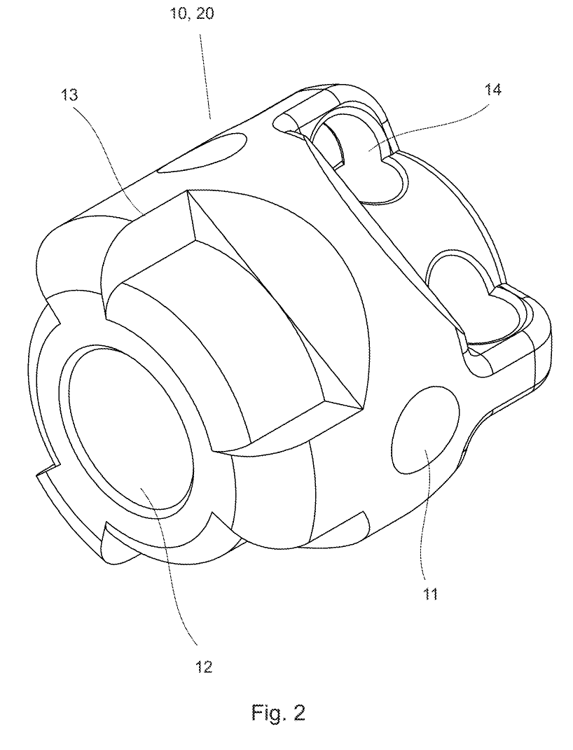

The cleaning device has two solid bodies, a first body 10 and a second body 20. An embodiment of these bodies is illustrated in FIG. 2. The bodies are preferably made out of metal, such as aluminum or stainless steel. The first body and the second body both have apertures 11, 12 defined therein for connecting a drive shaft 30 to them. The bodies connect to the same drive shaft 30 which can be rotated for rotating the bodies about a rotation axis (RA). Therefore the connector of the first body 10 includes the aperture 12 extending throughout the first body along the rotation axis. The connector of the second body 20 may include a similar aperture 12 as the first body 10 but also a recess or a socket configured to accommodate an end of the drive shaft can be used. Thus, the aperture 12 of the first body and the recess, socket or aperture of the second body should preferably be slightly larger in diameter than the drive shaft in order to push the drive shaft through the aperture of the first body and into the recess, socket or aperture of the second body. Preferably, two or more threaded apertures 11 are provided on the side of the aperture(s), recess or socket for accommodating tightening screws. An end of the drive shaft is pushed through the first body and at least into the second body and the drive shaft is secured to the connectors by tightening the tightening screws against the drive shaft. The drive shaft is preferably made of a steel cable or similar drive shaft that has some rigidity so that the cleaning device can be pushed forward in a pipe by pushing the drive shaft into the pipe but also some flexibility to be able to bend through bends of a pipeline.

In an embodiment, the first body has one or more recesses defined on its outer surface. Said one or more recesses can be made by e.g. milling the body. Said one or more recesses form one or more sharp cutting edges 13 on the outer periphery of the body for chipping away obstacles in a pipe if the pipe is more severely blocked than just a small layer on the inner surface. Preferably at least one sharp cutting edge 13 is defined in a plane perpendicular to the rotation axis and at least one sharp cutting edge parallel to the rotation axis for chipping away obstacles in a pipe in directions parallel and perpendicular to the rotation axis. Preferably, the cutting edge is partially curved and has a first cutting portion in plane perpendicular to the rotation axis and a second cutting portion parallel to the rotation axis. Similarly, the second body 20 may also comprises one or more recesses defining at least one cutting edge 13. In an embodiment, the first body and the second body are identical.

Both bodies, the first body and the second body, have multiple link connections 14 defined in the bodies for connecting links to the bodies. The link connections can be protrusions having a through hole in each of them or rings or loops defined on the bodies. Preferably, three, four, five or more link connections are defined in each body. Chains consisting of subsequent links 2 extend from one of the link connections of the first body to one of the link connections of the second body. Multiple chains are used and preferably one chain is connected with one link to each of the link connections of the bodies.

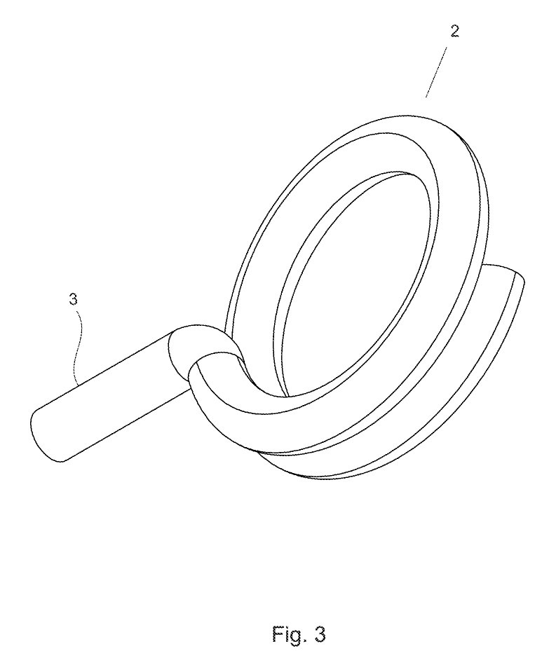

FIG. 3 illustrates an embodiment of the link in detail. The links 2 are made out of a metal wire that is helically wound so that the second round of the winding overlaps at least partially the first round of the winding and the first and the second round of the winding preferably make contact with each other. The second round of the winding does not have to overlap the first round of the winding completely but enough to prevent the links from unintentionally detaching from each other. The overlapping may be 10% or more or the overlapping may be 100% or less. In an embodiment, the overlapping may be even less than 10% and also more than 100% i.e. defining a third winding. The overlapping of the second winding is preferably about 50% of the circumference of the first winding. The links can have a generally round form or an oval form or any other suitable form. Chains can be formed from the links by forcing a gap between the first winding and an end of the second winding and inserting a second link to said gap and pulling the second link through said gap. The operation is similar to connection of keyrings together. Detaching of the links from each other or from the link connection can be done similarly.

Preferably, all of the links or at least a part of said links have a tip 3 of the helically wound metal wire bent radially outwardly from said helical winding for cleaning the inner surface of the pipe when the first body and the second body are rotated with the drive shaft. The tips 3 of the links 2 stick out of the chains and the tips make contact with the inner surface of the pipe when the bodies are rotated. The tips are preferably cut straight so that sharp circular edges are formed at distal ends of the tips thereby defining flat ends on the tips. If only part of the links have tips, then the links without the tips are located at the ends of the chains because the ends of the chains will less likely make contact with the inner surface of the pipe than the middle links of the chains.

The cleaning device that has two bodies and chains consisting of the described links between the bodies is fast and simple to manufacture. In a preferred embodiment, there are only two different parts needed, namely two bodies and multiple links. The working diameter of the cleaning device mainly depends on the number of links in the chains and the distance between the bodies on the drive shaft. Usable working diameter depends on the inner diameter of a pipe that is cleaned so the different working diameters are typically needed in every rehabilitation project. The working diameter can easily be adjusted by moving the bodies closer to each other for larger working diameter or further away from each other on the drive shaft for smaller working diameter. As there are no closed connections, i.e. by welding or soldering, the configuration of the cleaning device can be adjusted as needed, even on the working site and without have to use any special tools. For example, the chains can be elongated by adding links or shortened by removing links from the chains. The tips of the links wear out over time and the sharp edge at the end of the tip becomes dull or round, but it is a relatively fast and simple task to replace a worn out chain or a single link in the chain. This modular structure of the cleaning device enables assembly of the cleaning device at the working site and cleaning devices with the required working diameters can be assembled, as needed.

It is obvious to a person skilled in the art that, as the technology advances, that the inventive concept can be implemented in various ways. The present invention and its embodiments are not limited to the examples described above but may vary within the scope of the claims.

1. A cleaning device for cleaning an inner surface of a pipe, the cleaning device comprising:
a first body having a connector for connecting a drive shaft and being rotatable about a rotation axis with the drive shaft;
a second body having a connector for connecting the drive shaft and being rotatable about the rotation axis with the drive shaft;
multiple link connections defined in said first body and in said second body;
multiple chains of links extending between the multiple link connections of said first body and the multiple link connections of said second body, wherein
said multiple chains of links consisting of a helically wound metal wire for detachably connecting the multiple chains of links to each other and/or to the link connections and wherein at least a part of said multiple chains of links having a tip of the helically wound metal wire bent radially outwardly from said helically wound metal wire for cleaning an inner surface of the pipe by rotating the first body and the second body with the drive shaft.

2. The cleaning device of claim 1, wherein the connectors of the first body and the second body have an aperture or a recess defined therein for accommodating the drive shaft and threaded apertures in said first and second bodies for securing the drive shaft to said first and second bodies with screws.

3. The cleaning device of claim 1, wherein the helically wound metal wire links have a first winding and a second winding overlapping the first winding by at least 10% of a circumference of the first winding.

4. The cleaning device of claim 1, wherein the helically wound metal wire links have a first winding and a second winding overlapping the first winding by at most 100% of the circumference of the first winding.

5. The cleaning device of claim 1, wherein the first body has one or more recesses defined therein on an outer surface of the first body forming one or more sharp cutting edges on an outer periphery of the first body for chipping away obstacles in a pipe.

6. The cleaning device of claim 1, wherein the first body has one or more recesses defined therein on an outer surface of the first body forming at least one sharp cutting edge in a plane perpendicular to a rotation axis and at least one sharp cutting edge parallel to the rotation axis for chipping away obstacles in a pipe.

7. The cleaning device of claim 1, wherein the link connections of the first body and the second body are through holes defined within the first body and the second body.

8. The cleaning device of claim 1, wherein the first body and the second body are identical.

9. The cleaning device of claim 1, wherein the tip has a straight cut defining a flat end on the tip.
